(19) United States
(12) Patent Application Publication
(10) Pub. No.: US 2011/0188918 A1
(43) Pub. Date: Aug. 4, 2011

(54) Mechanical pencil

(75) Inventor: Hiroyuki Kanari, Fukushima-ken (JP)

(73) Assignee: MICRO CO., LTD.

(21) Appl. No.: 12/658,003

(22) Filed: Feb. 1, 2010

(51) Int. Cl. B43K 21/16; B43K 23/10

(52) U.S. Cl. 401/65; 401/98

(57) ABSTRACT

A mechanical pencil has a hollow longitudinal main body and a slider slidably mounted in a front end of the main body. The slider has a through-hole through which a lead is fed and a front end face formed into a spherical surface centering around the through-hole for contacting a writing surface during a writing operation of the mechanical pencil.

### BACKGROUND OF THE INVENTION

1. Field of the Invention

The present invention relates to a mechanical pencil for feeding out a lead from the front end of an annular pipe, and in particular, to a mechanical pencil having a slider disposed at the front end of an annular pipe for protecting a lead during a writing operation.

2. Background Information

Knocking-type mechanical pencils and automatic lead-feeding mechanical pencils are known. In the knocking-type mechanical pencil, a lead housed in an annular pipe is fed out from the front end of the annular pipe by a knocking operation. In the automatic lead-feeding mechanical pencil, a lead is automatically fed when the lead is worn away. Many of the foregoing types of mechanical pencils are constructed to protect the lead projected from the annular pipe. For example, in the conventional mechanical pencils shown in FIGS. 7 and 8, a lead-protecting portion 41 having a through-hole 40 is disposed at the front end of a slider 42. The slider 42 is disposed at a taper portion 43 disposed at the front end of the annular pipe so that the slider is movable in the axial direction. A lead 45 is projected from a front end opening portion 44 of the though-hole 40 for writing. The lead-protecting portion 41 is formed of a metal pipe made by cutting a stainless steel pipe material (FIG. 7) or a substantially pipe-like structure made of a plastic material (FIG. 8). Typically, at a front end of the lead-protecting portion 41 there is formed a substantially horizontal, flat front end face 46 that includes an opening portion 44 of the though-hole 40, and a small curved face is formed at a corner portion 47 at a front end outer periphery of the front end face 46.

Generally, when the mechanical pencils constructed as described above are used during a writing operation, writing is carried out on a surface 48 of a paper such that the annular pipe is inclined and the corner portion 47 at the front end outer periphery of the front end surface 46 of the slider 42 is in contact with the paper surface 48, as shown in FIG. 9. As a result, the corner portion 47 tends to scratch the paper surface 48 during a writing operation which leads to the generation of resistance during writing, an uncomfortable writing feeling, breakage of the paper surface, blurred letters, etc. Further, as shown in FIG. 9, due to the distance between the corner portion 47 of the flat front end face 46 and the opening portion 44 of the though-hole 40, the lead 45 is required to project from the opening portion 44 to a substantial extent, whereby during a writing operation the lead 45 tends to brake, particularly when the lead is thin.

### SUMMARY OF THE INVENTION

It is an object of the present invention to provide a mechanical pencil having a movable slider provided with a lead-protecting portion having a through-hole from which a lead projects during a writing operation such that, even when a front end portion of the slider is in contact with a paper surface during a writing operation, the generation of a large writing resistance is avoided and a good writing feeling is obtained, and the writing operation does not result in poor writing quality and/or damage to the paper surface.

Another object of the present invention is to provide a mechanical pencil that is simple in construction so that it may be fabricated economically and is convenient to use.

The foregoing and other objects of the present invention are carried out by a mechanical pencil comprising a hollow longitudinal main body and a slider slidably mounted in a front end of the main body. The slider has a through-hole through which a lead is fed and a front end face formed into a spherical surface centering around the through-hole for contacting a writing surface during a writing operation of the mechanical pencil.

In one embodiment, at least the spherical surface of the slider is made of a metallic material having a good sliding property, such as stainless steel. In another embodiment, at least the spherical surface of the slider is made of a plastic material having a low sliding resistance. In other embodiments, the entire slider is formed of a metallic material having a good sliding property or a plastic material having a low sliding resistance.

According to the mechanical pencil of the present invention, since the front end face of the slider is formed into a spherical surface centering around the through-hole of the slider, an opening portion of the through-hole opens at the top (front end) of the spherical surface, and a writing operation can be carried out under the condition that the lead projects slightly from the opening portion, thereby obviating any obstacles during the writing operation, such as a corner portion of a flat front end face of the slider as in the conventional mechanical pencils described above. Accordingly, even if writing is carried out while the spherical surface of the front end face of the slider always rests against the surface of the paper, writing can be carried out on the paper surface smoothly as a ball-point pen, i.e., the spherical surface is in smooth rolling contact with the paper surface, thereby obviating damage to the paper surface. Further, since the writing operation can be carried out under the condition that the lead projects slightly from the opening portion of the through-hole of the slider, the lead is not required to project extensively from the front end of the slider, thereby preventing breakage of the lead and, even if an extremely thin lead is used, the possibility of lead breakage is low.

Moreover, by further forming at least the spherical surface of the slider using a metallic material having a good sliding property or a plastic material having a low sliding resistance, a rolling contact between the spherical surface of the slider and the paper surface during a writing operation is increased, thereby enhancing the smooth rolling movement of the spherical surface against the paper surface during a writing operation, whereby writing can be carried out on the paper surface as smoothly as a ball-point pen.

### BRIEF DESCRIPTION OF THE DRAWINGS

The foregoing summary, as well as the following detailed description of preferred embodiments of the invention, will be better understood when read in conjunction with the accompanying drawings. For the purpose of illustrating the invention, there is shown in the drawings embodiments which are presently preferred. It should be understood, however, that the invention is not limited to the precise arrangement and instrumentalities shown. In the drawings:

FIG. 1 is a partial vertical cross-sectional view of a mechanical pencil according to one embodiment of the present invention;

FIG. 2 is an enlarged partial cross-sectional view showing one example of a front end portion of a slider of the mechanical pencil according to the present invention;

FIG. 3 is an enlarged partial cross-sectional view showing another example of the front end portion of a slider of the mechanical pencil according to the present invention;

FIG. 4 is an enlarged partial cross-sectional view showing an example of another embodiment of the mechanical pencil according to the present invention in which a cap member is disposed at an outer periphery of a front end portion of a slider;

FIG. 5 is an enlarged partial cross-sectional view showing another example of the mechanical pencil shown in FIG. 4 in which a cap member is disposed at an outer periphery of a front end portion of a slider;

FIG. 6 is an explanatory view showing the state in use of the mechanical pencil shown in FIG. 2;

FIG. 7 is an enlarged partial cross-sectional view of a front end portion of a slider in a conventional mechanical pencil;

FIG. 8 is an enlarged partial cross-sectional view of a front end portion of another slider in a conventional mechanical pencil; and

FIG. 9 is an explanatory view showing the state in use of the conventional mechanical pencil shown in FIG. 8.

### DETAILED DESCRIPTION OF THE PREFERRED EMBODIMENTS

While this invention is susceptible of embodiments in many different forms, this specification and the accompanying drawings disclose only one form as an example of the use of the invention. The invention is not intended to be limited to the embodiment so described, and the scope of the invention will be pointed out in the appended claims.

The present invention is described herein with a particular application to automatic mechanical pencils for feeding out a lead in such a manner that when the lead is consumed during writing, the lead is automatically fed out by releasing the writing tip from the paper surface. However, it is appreciated by those skilled in the art that the present invention is also suitable for other types of mechanical pencils, such as a knocking-type mechanical pencil in which a lead is fed out by knocking a knocking member disposed at a rear end or a side face of an annular pipe.

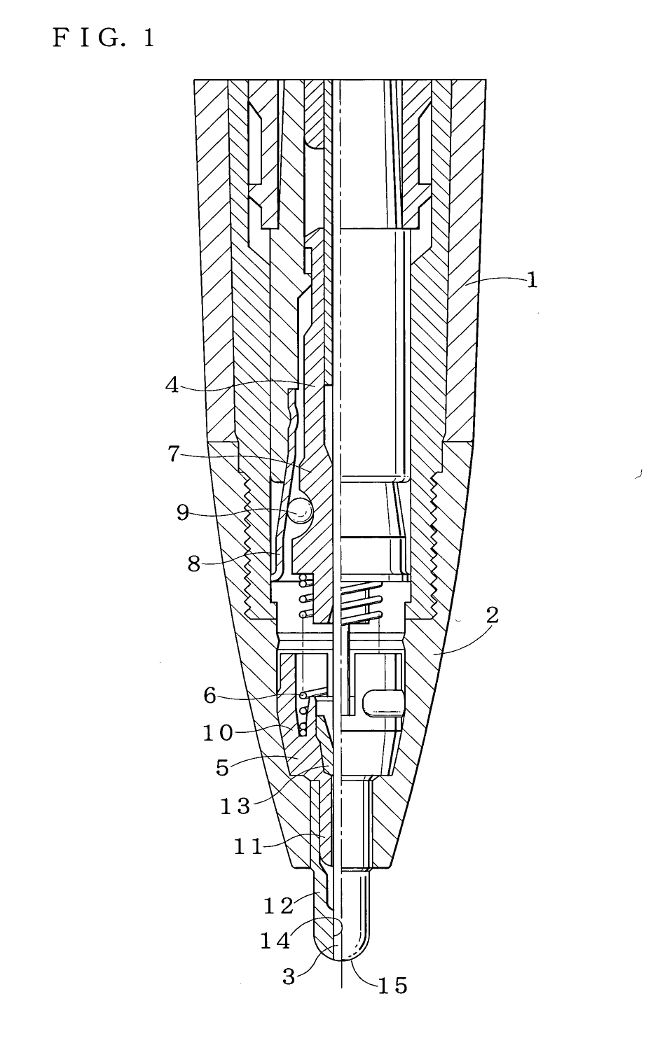

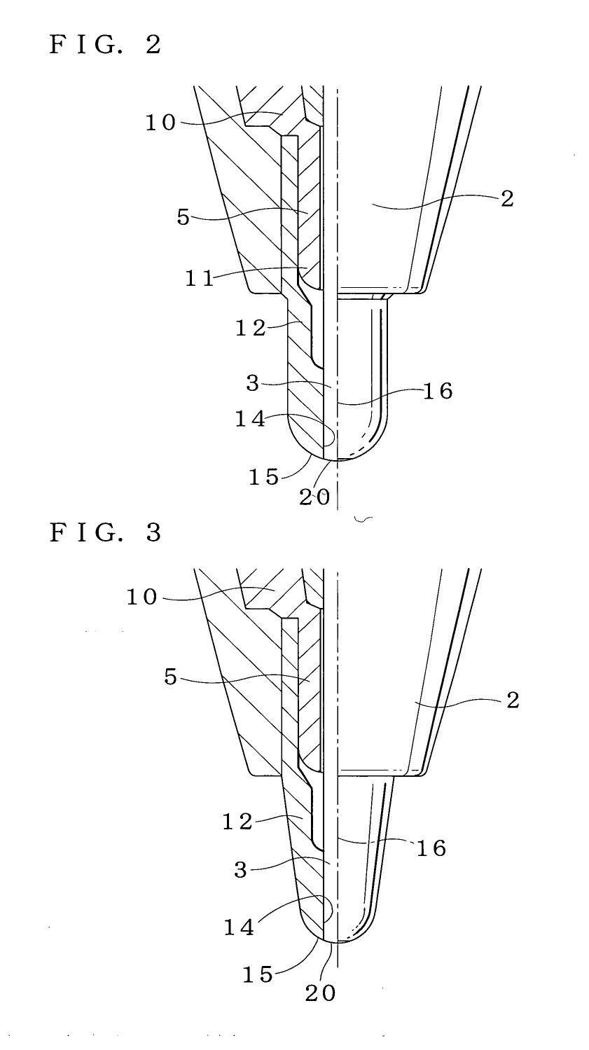

Referring now to the drawings in detail, wherein like numerals are used to indicate like elements throughout, there is shown in FIGS. 1-2 an embodiment of a mechanical pencil according to the present invention. The mechanical pencil has a hollow longitudinal main body in the form of an annular pipe 1 and a mouthpiece in the form of a taper member 2 threadedly mounted to a front end of the annular pipe 1. In the annular pipe 1, a chuck member 4 for gripping a lead 3 and a slider 5 are disposed movably in an axial direction of the annular pipe. Between the chuck member 4 and the slider 5, a spring 6 is disposed so as to bias or press the chuck member 4 rearward (upward in FIG. 1) towards a rear portion of the annular pipe 1 and at the same time press the slider 5 forward (downward in FIG. 1) towards a front portion of the annular pipe.

The chuck member 4 and the slider 5 may be constructed in various forms. In the embodiment shown in FIG. 1, for example, the chuck member 4 and the slider 5 have structures similar to the corresponding structures shown in U.S. Pat. No. 5,236,271 by which, as further described below, the retracting movement of the lead 3 is prevented but the advancing movement of the lead 3 is allowed. U.S. Pat. No. 5,236,271 is owned by the applicant as the present application and is incorporated herein by reference in its entirety. The structures of the chuck member 4 and the slider 5 in the mechanical pencil according to the present invention differ from the corresponding structures shown in U.S. Pat. No. 5,236,271 as described below and shown in the embodiments of FIGS. 1-6.

The chuck member 4 has a plurality of independent chuck elements 7 constructed so as to be able to grip the lead 3 when the chuck elements 7 are assembled into a tubular shape. The chuck member 4 is inserted into a chuck ring 8 of which the inner diameter is expanded via a ball 9 from the rear portion of the annular pipe 1 towards the front portion of the annular pipe. As shown in FIG. 1, when the chuck member 4 is moved to the rear portion of the annular pipe 1 by the spring 6, the chuck elements 7 are clamped by the action of the ball 9 and the chuck ring 8, by which the lead 3 is firmly gripped so that the lead will not be retracted, thereby making it possible to resist the writing pressure. On the other hand, when the lead 3 is pulled forward (downward in FIG. 1) against the spring 6, the chuck member 4 is also pulled forward, and the ball 9 faces a large inner diameter portion of the chuck ring 8, whereby the clamping with the chuck member 4 is loosened, and the lead 3 is released and allowed to move forward.

The slider 5 has a slider main body 10 and a lead-protecting portion 12 attached to a connecting portion 11 of the slider main body 10. In the embodiment shown in FIGS. 1-2, the slider main body 10 is made of a plastic material having a low sliding resistance and the lead-protecting portion 12 is made of a metallic material having a good sliding property, such as stainless steel. The slider main body 10 and the lead-protecting portion 12 are integrally connected to each other so that they move together as a single unit under the bias of the spring 6. However, both the slider main body 10 and the lead-protection portion 12 may be formed using either a metallic material having a good sliding property or a plastic material having a low sliding resistance.

The slider main body 10 of the slider 5 is provided with a lead-gripping portion 13 configured to elastically grip the lead 3. In the embodiment shown in FIG. 1, a lead-gripping portion 13 is made of a rubber material and is formed separately from and attached to the slider main body 10. However, when the slider main body 10 is formed of a plastic material having a low sliding resistance, an elastic gripping piece may be formed integrally with the slider main body 10 to form a lead-gripping portion (not shown) configured to elastically grip the lead 3.

The lead-protecting portion 12 of the slider 5 is formed into a substantially tubular-shaped pipe that is configured for integral attachment to the connecting portion 11 of the slider main body 10. The lead-protecting portion 12 has a through-hole 14 through which the lead 3 is fed, and projects forward from the taper member 2. By this construction, the lead 3 projects from the through-hole 14 of the lead-protecting portion 12 so that writing can be made onto the paper surface. When the lead 3 is worn away by the contact with the paper surface during writing, the slider 5 retracts following the wear of the lead 3. Thereafter, when a writing tip or front end of the lead 3 is released from the paper surface, the slider 5 moves forward by the action of the spring 6 while the slider 5 grips the lead 3 and, as described above, the chuck member 4 allows the lead 3 to move forward, whereby the lead is automatically fed out.

According to the present invention, a front end face 15 of the slider 5, and specifically the front end face of the lead-protecting portion 12 in the embodiment shown in FIG. 1, is formed into a spherical surface centering around the lead-feeding through-hole, namely, a center of the spherical surface is disposed on an axis 16 of the through-hole 14 of the lead-protecting portion 12. An outer periphery of the spherical surface is preferably formed so as to be continuous with an outer surface configuration of the lead-protecting portion 12.

As described above for the embodiment of the mechanical pencil shown in FIGS. 1-2, the slider main body 10 is made of a plastic material having a low sliding resistance and the lead-protecting portion 12 is made of a metallic material having a good sliding property, preferably a stainless steel material and the like. However, either the slider main body 10 and the lead-protecting portion 12, or both, may be formed of a ceramic material exhibiting a good sliding property.

In the embodiments of the mechanical pencil shown in FIGS. 1-2, the lead-protecting portion 12 is configured such that the portion thereof projecting from the taper member 2 has a substantially columnar shape with a substantially constant outer diameter. Alternatively, as shown in FIG. 3, the portion of the lead-projecting portion 12 projecting from the taper member 2 may be formed with a substantially inverted conical shape with an outer diameter which tapers downward or becomes narrow towards the front end face 15 of the lead-projecting portion. The remaining structure of the mechanical pencil shown in FIG. 3 is as discussed above for the embodiment of FIGS. 1-2.

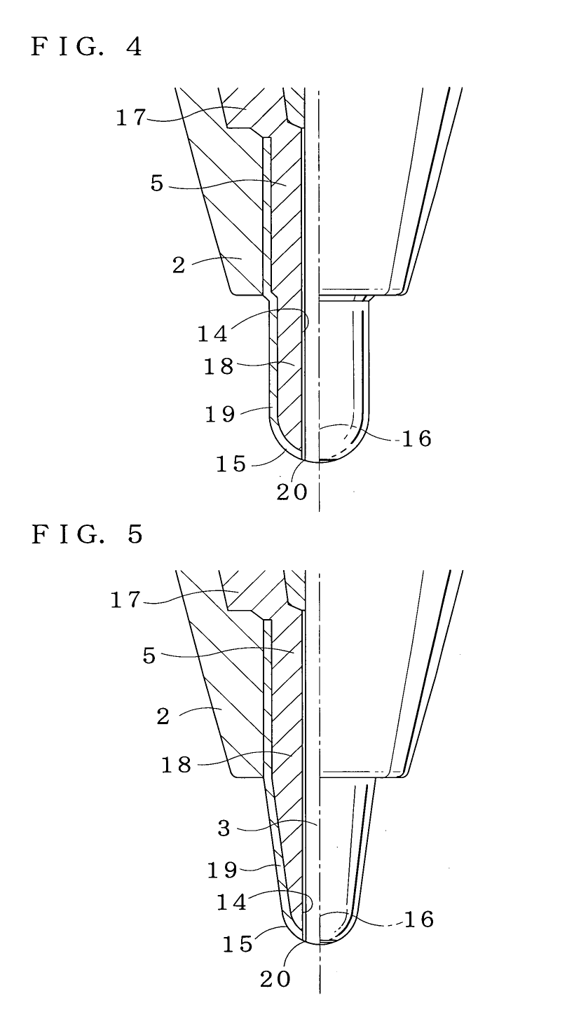

FIG. 4 shows another embodiment of the mechanical pencil according to the present invention. In FIG. 4, the slider 5 has a slider main body 17 and a lead-protecting portion 18 formed as an integral unit from a single piece of material. Thus, unlike the embodiments described above for FIGS. 1-3 in which the slider 5 is formed of two separate and independent members integrally connected together, the slider 5 in the embodiment of FIG. 4 is formed of a single, one-piece member. The lead-protecting portion 18 has a through-hole 14 through which the lead is fed, and projects forward from the taper member 2. An outer surface of the lead-protecting portion 18 is covered with a cap member 19. A front end face 15 of the slider 5 corresponding to the lead-protecting portion 18, including the portion of the cap member 19 forming part of the front end face 15, is formed into a spherical surface centering around the lead-feeding through-hole 14, namely, a center of the spherical surface is disposed on an axis 16 of the through-hole 14 of the lead-protecting portion 18. The spherical surface of the cap member 19 contacts the surface of the paper during a writing operation of the mechanical pencil. The slider 5 in FIG. 4 is preferably made of a plastic material and the cap 19 is preferably made of a metallic material having a sliding property, such as stainless steel. The remaining structure of the mechanical pencil shown in FIG. 4 is as discussed above for the embodiment of FIGS. 1-2.

In the embodiment of the mechanical pencil shown in FIG. 4, the lead-protecting portion 18 and cap member 19 covering the lead-protecting portion are configured such that the portions thereof projecting from the taper member 2 have a substantially columnar shape with a substantially constant outer diameter. Alternatively, as shown in FIG. 5, the portions of the lead-projecting portion 18 and corresponding cap member 19 projecting from the taper member 2 may be formed with a substantially inverted conical shape with an outer diameter which tapers downward or becomes narrow towards the front end face 15. The remaining structure of the mechanical pencil shown in FIG. 5 is as discussed above for the embodiment of FIG. 3.

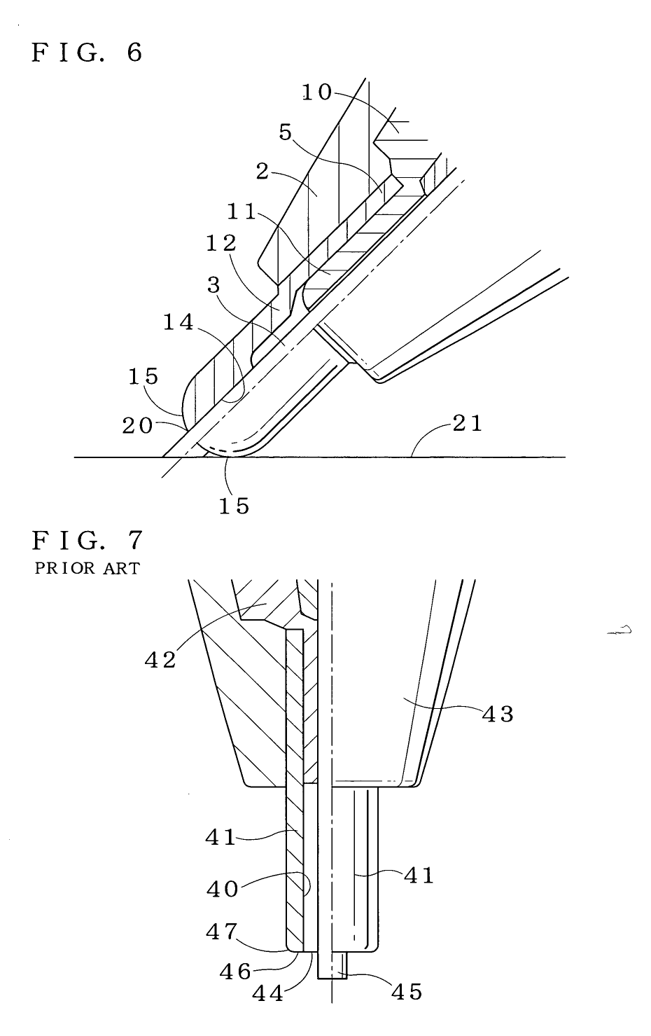

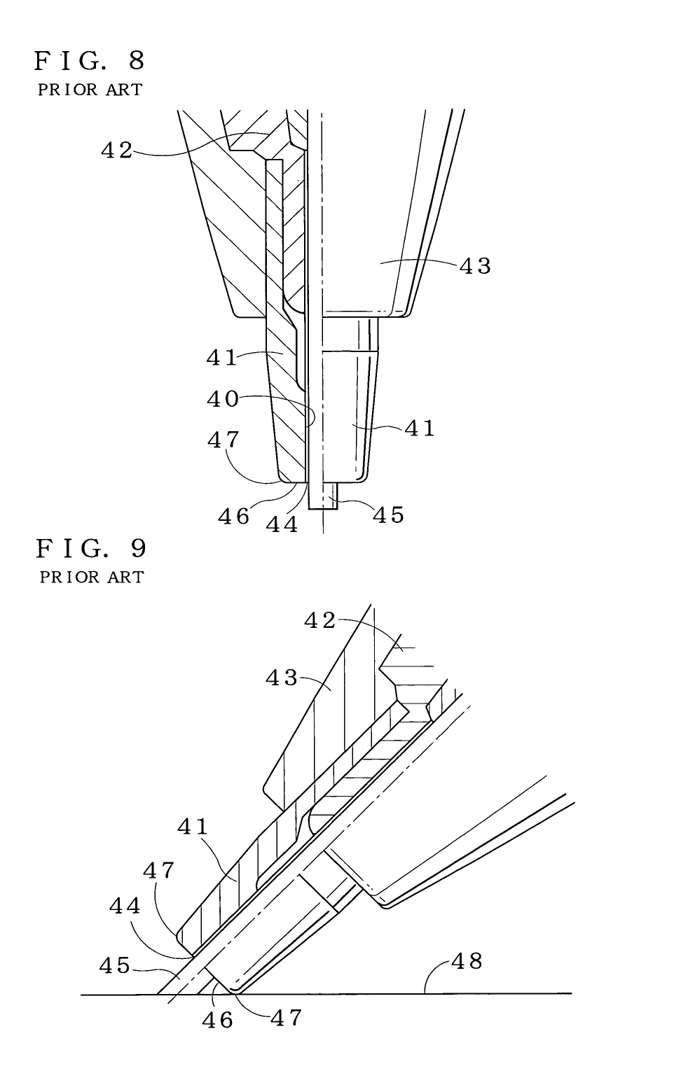

FIG. 6 shows the mechanical pencil according to the embodiment shown in FIGS. 1-2 in a state of writing on a paper surface 21. By forming the front end face 15 of the slider 5 into a spherical surface centering around the through-hole 14 of the lead-protecting portion 12, any obstacles during the writing operation, such a corner portion of a flat front end face of the slider as in the conventional mechanical pencil described above, are obviated. Thus, even if writing is carried out while the spherical surface of the front end face 15 always rests against the surface 21 of the paper, writing can be carried out on the paper surface smoothly as a ball-point pen, i.e., the spherical surface is in smooth rolling contact with the paper surface, thereby obviating damage to the paper surface.

Furthermore, by forming the front end face 15 of the slider 5 into a spherical surface centering around the through-hole 14 of the lead-protecting portion 12, an opening portion 20 of the through-hole 14 opens at the top (front end) of the spherical surface, and a writing operation can be carried out under the condition that the lead 3 only projects slightly from the opening portion. Accordingly, the lead is not required to project extensively from the front end of the slider, thereby preventing breakage of the lead and, even if an extremely thin lead is used, the possibility of lead breakage is low.

Moreover, by further forming at least the spherical surface of the slider using a metallic material having a good sliding property or a plastic material having a low sliding resistance, a rolling contact between the spherical surface of the slider and the paper surface during a writing operation is increased, thereby further enhancing the smooth rolling movement of the spherical surface against the paper surface during a writing operation, whereby writing can be carried out on the paper surface as smoothly as a ball-point pen.

The foregoing advantages described above in connection with the mechanical pencil of FIGS. 1-2 are also achieved by the mechanical pencils described above in connection with FIGS. 3-6.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A mechanical pencil comprising:
a hollow longitudinal main body; and
a slider slidably mounted in a front end of the main body, the slider having a through-hole through which a lead is fed and a front end face formed into a spherical surface centering around the through-hole for contacting a writing surface during a writing operation of the mechanical pencil.

2. A mechanical pencil according to claim 1; wherein at least the front end face of the slider is made of a metallic material having a sliding property.

3. A mechanical pencil according to claim 2; wherein the metallic material is stainless steel.

4. A mechanical pencil according to claim 1; wherein at least the front end face of the slider is made of a plastic material having a low sliding resistance.

5. A mechanical pencil according to claim 1; wherein the slider comprises a slider main body and a lead-protecting portion integrally attached to a connecting portion of the slider main body, the lead-protecting portion having the front end face formed into the spherical surface.

6. A mechanical pencil according to claim 5; wherein the lead-protecting portion is made of a metallic material having a sliding property.

7. A mechanical pencil according to claim 6; wherein the metallic material is stainless steel.

8. A mechanical pencil according to claim 5; wherein the lead-protecting portion is made of a plastic material having a low sliding resistance.

9. A mechanical pencil according to claim 5; wherein the slider main body is made of a plastic material and the lead-protecting portion is made of a metallic material having a sliding property.

10. A mechanical pencil according to claim 5; wherein both of the slider main body and the lead-protecting portion are made of one of a metallic material having a sliding property and a plastic material having a low sliding resistance.

11. A mechanical pencil according to claim 5; further comprising a cap member covering the lead-protecting portion of the slider, the cap member being made of a metallic material having a sliding property.

12. A mechanical pencil according to claim 1; wherein the slider is a unitary structure made of a single piece of material, the slider having a slider main body and a lead-protecting portion having the front end face formed into the spherical surface.

13. A mechanical pencil according to claim 12; wherein the entire slider is made of one of a metallic material having a sliding property and a plastic material having a low sliding resistance.

14. A mechanical pencil comprising:
a hollow longitudinal main body;
a mouthpiece mounted to a front end of the main body; and
a slider slidably mounted in the front end of the main body, the slider having a slider main body and a lead-protecting portion attached to the slider main body, the lead-protecting portion having a through-hole through which a lead is fed and which projects forward from the mouthpiece, a front end face of the slider corresponding to the lead-protecting portion being formed into a spherical surface centering around the lead-feeding through-hole of the lead-protecting portion for contacting a writing surface during a writing operation of the mechanical pencil.

15. A mechanical pencil according to claim 14; wherein the lead-protecting portion that projects from the mouthpiece has a substantially columnar shape with a substantially constant outer diameter.

16. A mechanical pencil according to claim 15; wherein the slider main body and the lead-protecting portion of the slider are formed as an integral unit from a single piece of material.

17. A mechanical pencil according to claim 16; wherein the single piece of material is a metallic material having a sliding property.

18. A mechanical pencil according to claim 16; wherein the single piece of material is a plastic material having a low sliding resistance.

19. A mechanical pencil according to claim 16; wherein the single piece of material is a plastic material; and further comprising a cap member covering the lead-protecting portion, the cap member being made of a metallic material having a sliding property.

20. A mechanical pencil according to claim 14; wherein the lead-protecting portion that projects from the mouthpiece has a substantially inverted conical shape with an outer diameter which tapers downward towards the front end face of the slider.

21. A mechanical pencil according to claim 20; wherein the slider main body and the lead-protecting portion of the slider are formed as an integral unit from a single piece of material.

22. A mechanical pencil according to claim 21; wherein the single piece of material is a metallic material having a sliding property.

23. A mechanical pencil according to claim 21; wherein the single piece of material is a plastic material having a low sliding resistance.

24. A mechanical pencil according to claim 21; wherein the single piece of material is a plastic material; and further comprising a cap member covering the lead-protecting portion, the cap member being made of a metallic material having a sliding property.
